(19) United States
(12) Patent Application Publication
(10) Pub. No.: US 2023/0221175 A1
(43) Pub. Date: Jul. 13, 2023

(54) PREDICTION AND DETECTION OF FILTER CLOGS

(71) Applicant: Carrier Corporation, Palm Beach Gardens, FL (US)

(72) Inventors: Srinivasa Reddy Pilli, Hyderabad (IN); Pradeep Kumar Sappati, Hyderabad (IN); Vinayak Rao Eluri, Hyderabad (IN); Dinesh Sanapala, Hyderabad (IN); Ashoka Thimma Reddy, Hyderabad (IN)

(21) Appl. No.: 18/152,796

(22) Filed: Jan. 11, 2023

Related U.S. Application Data
(60) Provisional application No. 63/299,108, filed on Jan. 13, 2022.

(51) Int. Cl. G01J 1/04; G01J 1/02; G01J 1/42

(52) U.S. Cl. CPC G01J 1/0425; G01J 1/0238; G01J 1/4257

(57) ABSTRACT

A system and method for determining a filter clog. A method includes providing light to a fiber optic cable arranged on a filter, transmitting the light from the fiber optic cable, and detecting an intensity of the light. The method may include predicting a filter clog based on the detection of the intensity of the light; and providing an indication of the filter clog.

### CROSS-REFERENCE TO RELATED APPLICATIONS

This application claims the benefit of U.S. Provisional Application No. 63/299,108 filed Jan. 13, 2022, all of which are incorporated herein by reference in their entirety.

### BACKGROUND

The present disclosure relates to filtration systems, and more specifically, to the prediction and detection of filter clogs.

Heating, ventilation, and air conditioning (HVAC) systems are commonly used to control temperature and air quality in the interior space of various dwellings. With many HVAC installations, a disposable air filter is conventionally employed. Such filters often include a frame and a fibrous filter material and may include a reinforcing structure to help support the filter material. After a period of use, these filters become dirty or clogged and must be cleaned or replaced. Proper filter maintenance helps keep the HVAC system operating at maximum efficiency, reduces operating costs, and better ensures desired indoor air quality; further, continuing to run an HVAC system with an excessively clogged filter can negatively affect the expected useful life of various HVAC system components.

### BRIEF DESCRIPTION

According to an embodiment, a method for determining a filter clog is provided. The method can include providing, via a light transmitter, light to a fiber optic cable arranged on a filter; transmitting, via the fiber optic cable, the light from the fiber optic cable; detecting, via the receiver, an intensity of the light; predicting a filter clog based on the detection of the intensity of the light; and providing an indication of the filter clog.

In addition to one or more of the features described herein, or as an alternative, further embodiments include using a series of fiber optic cables.

In addition to one or more of the features described herein, or as an alternative, further embodiments include horizontally arranging a series of fiber optic cables across the filter.

In addition to one or more of the features described herein, or as an alternative, further embodiments include identifying a location of the filter clog on the filter based on a group of fiber optic cables of the series of fiber optic cables.

In addition to one or more of the features described herein, or as an alternative, further embodiments include vertically arranging a series of fiber optic cables across the filter.

In addition to one or more of the features described herein, or as an alternative, further embodiments include identifying a location of the filter clog on the filter based on a group of fiber optic cables of the series of fiber optic cables.

In addition to one or more of the features described herein, or as an alternative, further embodiments include using a first series of fiber optic cables arranged horizontally across the filter and a second series of fiber optic cables arranged vertically across the filter.

In addition to one or more of the features described herein, or as an alternative, further embodiments include arranging a first series of fiber optic cables perpendicular to a second series of fiber optic cables.

According to another embodiment, a system for determining a filter clog is provided. The system can include a filter coupled to an HVAC system for filtering particulates; a light transmitter arranged on a first side of the filter; a light receiver arranged on a second side of the filter, wherein the first side of the filter is opposite the second side of the filter; and a series of fiber optic cables coupled to the light receiver and extending across the filter towards the second side of the filter.

In addition to one or more of the features described herein, or as an alternative, further embodiments include a light emitting diode (LED) source.

In addition to one or more of the features described herein, or as an alternative, further embodiments include a solar powered light source.

In addition to one or more of the features described herein, or as an alternative, further embodiments include a controller that is configured to determine a filter clog based at least in part on a light intensity detected by the light receiver.

In addition to one or more of the features described herein, or as an alternative, further embodiments include each fiber optic cable of the series of fiber optic cables is arranged in parallel.

In addition to one or more of the features described herein, or as an alternative, further embodiments include a series of fiber optic cables that are arranged horizontally across the filter.

In addition to one or more of the features described herein, or as an alternative, further embodiments include a controller that is configured to identify a location of a filter clog on the filter based on a group of fiber optic cables of the series of fiber optic cables.

In addition to one or more of the features described herein, or as an alternative, further embodiments include a series of fiber optic cables are arranged vertically across the filter.

In addition to one or more of the features described herein, or as an alternative, further embodiments include a controller that is configured to identify a location of a filter clog on the filter based on a group of fiber optic cables of the series of fiber optic cables.

In addition to one or more of the features described herein, or as an alternative, further embodiments include a first series of fiber optic cables arranged horizontally across the filter and a second series of fiber optic cables arranged vertically across the filter.

In addition to one or more of the features described herein, or as an alternative, further embodiments include a first series of fiber optic cables that are arranged perpendicular to the second series of fiber optic cables.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1A depicts an exemplary system for predicting and detecting filter clogs in accordance with one or more embodiments of the disclosure;

FIG. 1B depicts an exemplary system for predicting and detecting filter clogs in accordance with one or more embodiments of the disclosure;

FIG. 2 depicts a generic processor in accordance with one or more embodiments of this disclosure; and

FIG. 3 depicts a flow chart of a process for predicting and detecting filter clogs in accordance with one or more embodiments of the disclosure.

### DETAILED DESCRIPTION

Current air filters may come equipped with or may be coupled to complex sensing devices. Other air filters may not include any sensing device for predicting and providing the filter clog information to an end-user/customer. Timely prediction can help purify the air and not compromise the indoor air quality (IAQ). The devices used in smart filters are costly and may consume significant amounts of energy if they are used continuously for sending feedback to the thermostat for replacing the filter or cleaning the filter. On the other hand, non-smart filters do not have any intelligence to detect and inform the end-user.

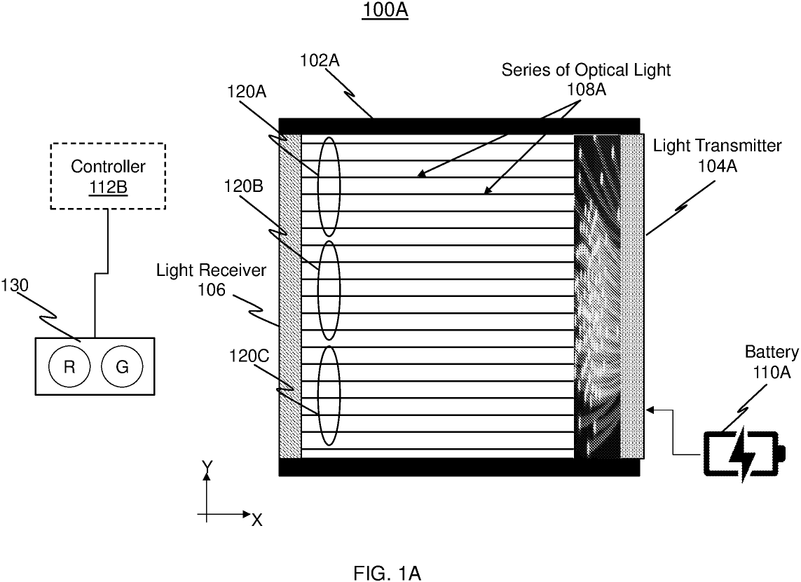

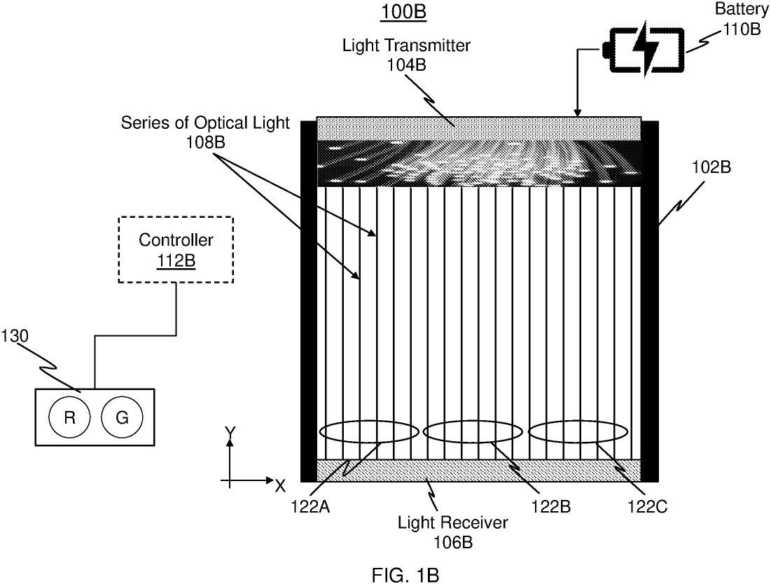

Now referring to FIG. 1A, an exemplary system 100A for predicting and detecting filter clogs in accordance with one or more embodiments of the disclosure is shown. FIG. 1A depicts a filter 102A that is configured to filter particulates out of the air. In a non-limiting example, the filter 102A may include a replaceable or non-replaceable filter. On a first side of the filter, a light transmitter 104A may be arranged to operate as a light source. In one or more embodiments of the disclosure, the light transmitter 104A may be a low-power light-emitting diode (LED) or other low-power light source. The light source may be coupled to an energy storage device 110A such as a battery. In other embodiments of the disclosure, the energy storage device 110A can be configured to harness energy from solar, wind, or other alternative energy sources.

On a second side of the filter, a light receiver 106A may be arranged to receive and detect the light from the light transmitter 104A. A series of fiber optics 108A can be arranged across the filter 102A to detect the light emitted from the light transmitter 104A. In this non-limiting example, the series of fiber optic cables 108A are arranged horizontally across the filter 102A.

FIG. 1A also depicts a controller 112A that is configured to process the light information from the receiver. The controller 112A is configured to analyze the amount of light that is detected from the light transmitter 104A and based on the intensity of the light, a clogged filter can be identified. In one or more embodiments of the disclosure, various thresholds may be configured in the controller 112A to determine the level of a build-up of particulate matter on the filter 102A. For example, the controller 112A may be connected to a LED array 130 to provide an indication of the status of the filter based on the processed light information such as when the filter is in good condition or the filter requires replacement and/or cleaning. Such an LED array 130 can comprise a red LED (R) and a green LED (G) to provide a visual indication of the status of the filter. The green LED (G) may flash at configurable intervals to indicate the filters are in good condition (not-clogged state). The red LED (R) can be operated to indicated the filters require cleaning and/or replacement. In some embodiments, one or more groups can be formed in the series of fiber optic cables 108A to monitor and determine what portion of the filter 102A may have a build-up of particulates or a clog. For example, the fiber optic cables 108A are arranged in three different groups 120A, 120B, and 120C. If group 120A of the fiber optic cable 108A provides light information indicating a blockage, a user can be alerted that the top portion of the filter 102A is clogged or has reached a threshold level of blockage. Similarly, the other portions of the filter 102A can be monitored by groups 120B, 120C by providing the light information from the light receiver 106A to the controller 112A.

In one or more embodiments of the disclosure, the light receiver, fiber optic cables, and light transmitter can be arranged in a frame that may be affixed to an existing filter providing a retrofitted solution. Other embodiments of the disclosure may provide a solution where the light receiver and the light transmitter may be affixed to the filtration system that is configured to receive the removable filters.

Now referring to FIG. 1B, an exemplary system 100B for predicting and detecting filter clogs in accordance with one or more embodiments of the disclosure. Similar to the filter 102A shown in FIG. 1A, a filter 102B can include a light transmitter 104B, light receiver 106B, and fiber optic cables 108B. In addition, the light receiver 106B may be powered by an energy storage device 110B. In this non-limiting example, the series of fiber optic cables 108B is arranged vertically across the filter 102B. The light transmitter can be coupled to a low-power energy storage device 110B, and a controller 112B configured to process the light information to determine a blockage. For example, the controller 112B may be connected to a LED array 130 to provide an indication of the status of the filter based on the processed light information such as when the filter is in good condition or the filter requires replacement and/or cleaning.

In some embodiments, one or more groups can be formed in the series of fiber optic cables 108B to monitor and determine what portion of the filter 102B may have a build-up of particulates or a clog. For example, the fiber optic cables 108B are arranged in three different groups 122A, 122B, and 122C. If group 122A of the fiber optic cables 108B provides light information indicating a blockage, a user can be alerted that the left portion of the filter 102B is clogged or has reached a threshold level of blockage. Similarly, the other portions of the filter 102B can be monitored by groups 120B, 120C by providing the light information from the light receiver 106B to the controller 112B.

In a further embodiment, the series of fiber optics cables 108A from FIG. 1A can be overlayed and arranged perpendicular to the series of fiber optics cables 108B shown in FIG. 1B on a single filter.

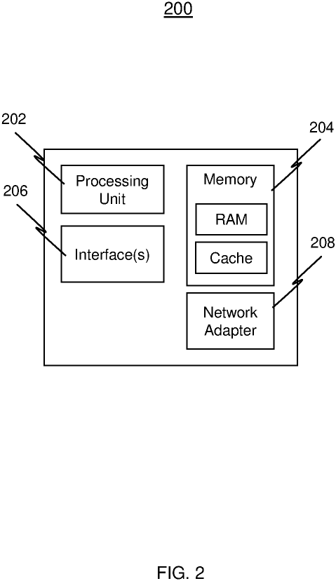

Referring now to FIG. 2, in which an exemplary controller 200, representative of a controller 112A, 112B such as that shown in FIGS. 1A and 1B. The controller 200 is only illustrative and is not intended to suggest any limitation as to the scope of use or functionality of embodiments of the invention described herein. As shown in FIG. 2, controller 200 is shown in the form of a general-purpose computing device. The components of controller 200 may include, but are not limited to, one or more processors 202, a memory 204, interface 206, and network adapter 208. In one or more embodiments of the disclosure, the processor 202 can include a processor 202 of a general-purpose computer, special purpose computer, or other programmable data processing apparatus configured to execute instruction via the processor of the computer or other programmable data processing apparatus.

Controller 200 can include a variety of computer system readable media. Such media may be any available media that is accessible by controller 200, and it includes both volatile and non-volatile media, removable and non-removable media. Memory 204 can include computer system readable media. The memory 204 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), etc.). Controller 200 may further include other removable/non-removable, volatile/non-volatile computer system storage media. The processor 202 and a memory 204 are configured to carry out the operations for the nodes. The memory 204 may include one or more program modules (not shown) such as operating system(s), one or more application programs, other program modules, and program data. Each of the operating systems, one or more application programs, other program modules, and program data or some combination thereof, may include an implementation of a networking environment. The program modules generally carry out the functions and/or methodologies of embodiments of the invention as described herein.

Controller 200 may also communicate with one or more external devices through the interface 206 such as a keyboard, a pointing device, a display, etc.; one or more devices that enable a user to interact with controller 200; and/or any devices (e.g., network card, modem, etc.) that enable controller 200 to communicate with one or more other computing devices.

Still yet, controller 200 can communicate with one or more networks such as a local area network (LAN), a general wide area network (WAN), and/or a public network (e.g., the Internet) via network adapter 208. As depicted, network adapter 208 communicates with the other components of controller 200. It should be understood that although not shown, other hardware and/or software components could be used in conjunction with controller 200.

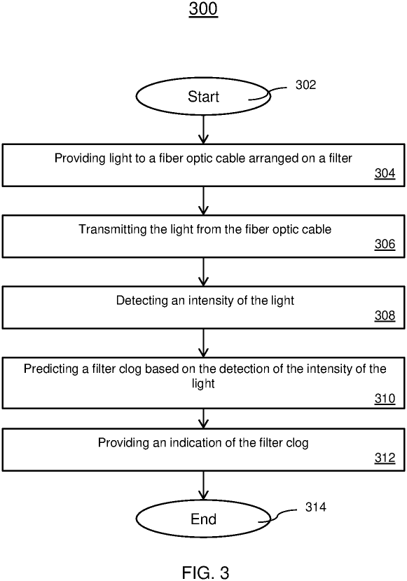

FIG. 3 depicts a flowchart of a method 300 for determining a filter clog in accordance with one or more embodiments of the disclosure. The method 300 can be implemented in a system such as that shown in FIGS. 1A and 1B. Method 300 begins at block 302 and continues to block 304, where the light transmitter provides a light to a fiber optic cable arranged on a filter. In one or more embodiments of the disclosure, the filter is an HVAC filter that is configured to remove particulates from an area. At block 306, the fiber optic cable transmits the light from the fiber optic cable. In one or more embodiments of the disclosure the fiber optic cable may include a series of fiber optic cables. The series of fiber optic cables can be arranged horizontally across or vertically across the filter. In further embodiments, the fiber optic cables can include a first series of fiber optic cables arranged horizontally across the filter and a second series of fiber optic cables arranged vertically across the filter, where the first series of fiber optic cables are arranged perpendicular to the second series of fiber optic cables.

At block 308, a receiver is configured to detect an intensity of the light. At block 310, a controller can be configured to predict a filter clog based on the detection of the intensity of the light. The controller can be configured to identify a location of the filter clog on the filter based on a group of fiber optic cables of the series of fiber optic cables. At block 312, the controller configured to provide an indication of the filter clog. Method 300 ends at block 314. The process flow diagram of FIG. 3 is not intended to indicate that the operations of the method 300 are to be executed in any particular order, or that all of the operations of the method 300 are to be included in every case. Additionally, the method 300 can include any suitable number of additional operations.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method for determining a filter clog, the method comprising:
providing, via a light transmitter, light to a fiber optic cable arranged on a filter;
transmitting, via the fiber optic cable, the light from the fiber optic cable;
detecting, via the receiver, an intensity of the light;
predicting a filter clog based on the detection of the intensity of the light; and
providing an indication of the filter clog.

2. The method of claim 1, wherein the fiber optic cables comprise a series of fiber optic cables.

3. The method of claim 2, wherein the series of fiber optic cables are arranged horizontally across the filter.

4. The method of claim 3, further comprises identifying a location of the filter clog on the filter based on a group of fiber optic cables of the series of fiber optic cables.

5. The method of claim 2, wherein the series of fiber optic cables are arranged vertically across the filter.

6. The method of claim 5, further comprises identifying a location of the filter clog on the filter based on a group of fiber optic cables of the series of fiber optic cables.

7. The method of claim 2, wherein the fiber optic cables comprise a first series of fiber optic cables arranged horizontally across the filter and a second series of fiber optic cables arranged vertically across the filter.

8. The method of claim 7, wherein the first series of fiber optic cables are arranged perpendicular to the second series of fiber optic cables.

9. A system comprising:
a filter coupled to an HVAC system for filtering particulates;
a light transmitter arranged on a first side of the filter;
a light receiver arranged on a second side of the filter, wherein the first side of the filter is opposite the second side of the filter; and
a series of fiber optic cables coupled to the light receiver and extending across the filter towards the second side of the filter.

10. The system of claim 9, wherein the light transmitter is a light emitting diode (LED) source.

11. The system of claim 9, wherein the light transmitter comprises a solar powered light source.

12. The system of claim 9, further comprising a controller configured to determine a filter clog based at least in part on a light intensity detected by the light receiver.

13. The system of claim 9, wherein each fiber optic cable of the series of fiber optic cables is arranged in parallel.

14. The system of claim 12, wherein the series of fiber optic cables are arranged horizontally across the filter.

15. The system of claim 14, wherein the controller is further configured to identify a location of a filter clog on the filter based on a group of fiber optic cables of the series of fiber optic cables.

16. The system of claim 12, wherein the series of fiber optic cables are arranged vertically across the filter.

17. The system of claim 16, wherein the controller is further configured to identify a location of a filter clog on the filter based on a group of fiber optic cables of the series of fiber optic cables.

18. The system of claim 9, wherein the fiber optic cables comprise a first series of fiber optic cables arranged horizontally across the filter and a second series of fiber optic cables arranged vertically across the filter.

19. The system of claim 18, wherein the first series of fiber optic cables are arranged perpendicular to the second series of fiber optic cables.
